(19) United States
(12) Patent Application Publication
(10) Pub. No.: US 2024/0363854 A1
(43) Pub. Date: Oct. 31, 2024

(54) METHOD AND FABRICATION OF METAL-SULFIDE-BASED LI-ION CAPACITORS (LICS) FOR HIGH-ENERGY AND HIGH-POWER DENSITY APPLICATIONS

(71) Applicant: Khalifa University of Science and Technology, Abu Dhabi (AE)

(72) Inventors: Daniel CHOI, Abu Dhabi (AE); Abhishek Chandrakant LOKHANDE, Abu Dhabi (AE)

(21) Appl. No.: 18/688,149

(22) PCT Filed: Jul. 15, 2022
(86) PCT No.: PCT/US2022/037313

§ 371 Date: Feb. 29, 2024

Related U.S. Application Data
(60) Provisional application No. 63/241,425, filed on Sep. 7, 2021.

(51) Int. Cl. H01M 4/58; H01G 11/24; H01G 11/36; H01G 11/50; H01G 11/52; H01G 11/86; H01M 4/02; H01M 4/62

(52) U.S. Cl. CPC H01M 4/5815; H01G 11/24; H01G 11/36; H01G 11/50; H01G 11/52; H01G 11/86; H01M 4/625; H01M 2004/021; H01M 2004/027

(57) ABSTRACT

Methods of preparing metal-sulfide particles, such as for use in lithium-ion capacitors may include preparing a precursor solution. The precursor solution may include a copper-containing precursor and a metal-containing precursor. The methods may include mixing the precursor solution with water to form an aqueous precursor solution. The methods may include adding a sulfur-containing precursor to the aqueous precursor solution to form a sulfur-containing aqueous precursor solution. The methods may include heating the sulfur-containing aqueous precursor solution. The methods may include recovering a precipitate from the sulfur-containing aqueous precursor solution. The precipitate may be or include metal-sulfide particles.

### CROSS-REFERENCES TO RELATED APPLICATIONS

This application claims the benefit of U.S. Provisional Application No. 63/241,425 filed on Sep. 7, 2021, the entire contents of which are hereby incorporated for all purposes in their entirety.

### TECHNICAL FIELD

The present technology relates to energy storage systems. More specifically, the present technology relates to materials suitable for lithium-ion capacitors.

### BACKGROUND OF THE INVENTION

Lithium-ion capacitors (LICs) exhibit the combined advantages of lithium-ion batteries and supercapacitors. LICs are hybrid types of capacitors classified as a type of supercapacitors. The anode may be the same or similar to anodes used in lithium-ion batteries. The cathode may be the same or similar to cathodes used in supercapacitors. Electrode materials may be classified into three types, including: insertion type, conversion type, and alloying type. Insertion type electrodes may have high de-lithination potential that limits their output voltage and, therefore, energy density. Conversion type electrodes may suffer from volume expansion issues and, therefore, gradual capacity loss after cycling. Alloying type electrodes may also suffer from volume expansion issues and, therefore, gradual capacity loss after cycling.

Thus, there is a need for improved LICs that can be used to produce high quality devices. These and other needs are addressed by the present technology.

### SUMMARY

Embodiments of the present disclosure may include method of preparing metal-sulfide particles. The methods may include preparing a precursor solution. The precursor solution may include a copper-containing precursor and a metal-containing precursor. The methods may include mixing the precursor solution with water to form an aqueous precursor solution. The methods may include adding a sulfur-containing precursor to the aqueous precursor solution to form a sulfur-containing aqueous precursor solution. The methods may include heating the sulfur-containing aqueous precursor solution. The methods may include recovering a precipitate from the sulfur-containing aqueous precursor solution. The precipitate may include metal-sulfide particles.

In some embodiments, the metal-containing precursor may be a tin-containing precursor or an iron-containing precursor. The metal-containing precursor may be a tin-containing precursor. The aqueous precursor solution may include between about 0.05 M and about 0.35 M CuCl₂H₄O₂. The aqueous precursor solution may include between about 0.05 M and about 0.20 M SnCl₄. The methods may include adding a carbon-containing material to the aqueous precursor solution. The carbon-containing material may be or include carbon nanotubes or graphene. The methods may include adding a lanthanum-containing precursor, a samarium-containing precursor, or a combination thereof to the precursor solution, the aqueous precursor solution, or the sulfur-containing aqueous precursor solution.

Some embodiments of the present disclosure encompass lithium-ion anodes. The anodes may include metal-sulfide particles. The metal-sulfide particles may include one or more of copper, tin, or iron. The anodes may include a carbon-containing material at least partially encapsulating the metal-sulfide particles.

In some embodiments, the lithium-ion anode may include a three-dimensional structure having a porous morphology. The metal-sulfide particles may include copper, tin, and sulfur. The metal-sulfide particles may include between about 20 at. % and about 40 at. % copper, between about 5 at. % and about 25 at. % tin, and between about 40 at. % and about 70 at. % sulfur. The carbon-containing material may be or include carbon nanotubes or graphene. The metal-sulfide particles may be doped with one or more elements characterized by an atomic number of greater than 50. The metal-sulfide particles comprise Cu₂SnS₃.

Some embodiments of the present disclosure encompass LICs. The capacitors may include a cathode, an anode, and an electrolyte. The anode may include metal-sulfide particles that are at least partially encapsulated by a carbon-containing material.

In some embodiments, the cathode may be or include activated carbon. The electrolyte may be or include ethylene carbonate and diethyl carbonate. The electrolyte may include lithium hexafluorophosphate. The capacitors may include a separator between the cathode and the anode. The separator may be or include a polypropylene membrane. A surface of the anode may be characterized by nanospheres ranging in size between about 10 nm and about 75 nm. The cathode, the anode, or both may be formed free of a binder material. The anode may be doped with one or more elements characterized by an atomic number of greater than 50.

Such technology may provide numerous benefits over conventional technologies. For example, the metal-sulfide particles may exhibit increased electrochemical properties. Additionally, the carbon-containing material may provide increase the electrochemical properties of the formed material, while simultaneously reducing shortcomings of metal-sulfide particles independently. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the drawings.

FIG. 1 shows a schematic cross-sectional view of an exemplary lithium-ion supercapacitor according to some embodiments of the present technology.

FIG. 2 shows exemplary operations in a method of preparing metal-sulfide particles according to some embodiments of the present technology.

FIG. 3A shows a Field Emission Scanning Electron Microscope image of an electrode according to some embodiments of the present technology.

FIG. 3B shows a Transmission Emission Microscopy image of an electrode according to some embodiments of the present technology.

FIG. 3C shows another Transmission Emission Microscopy image of an electrode according to some embodiments of the present technology.

FIG. 3D shows a Selected Area Electron Diffraction pattern of an electrode according to some embodiments of the present technology.

FIGS. 3E, 3F, 3G, 3H, and 3I show elemental mapping of an electrode according to some embodiments of the present technology.

FIGS. 3J, 3K, 3L, and 3M show X-ray Photoelectron Spectroscopy of materials in an electrode according to some embodiments of the present technology.

FIG. 4A shows a Powder X-ray Diffraction Spectrum of metal-sulfide particles according to some embodiments of the present technology.

FIGS. 4B, 4C, and 4D show X-ray Photoelectron Spectroscopy of materials in an electrode according to some embodiments of the present technology.

FIG. 5A shows a Field Emission Scanning Electron Microscope image of metal-sulfide particles according to some embodiments of the present technology.

FIG. 5B shows a Transmission Emission Microscopy image of metal-sulfide particles according to some embodiments of the present technology.

FIG. 5C shows another Transmission Emission Microscopy image of metal-sulfide particles according to some embodiments of the present technology.

FIG. 5D shows a Selected Area Electron Diffraction pattern of metal-sulfide particles according to some embodiments of the present technology.

FIGS. 5E, 5F, 5G, and 5H show elemental mapping of metal-sulfide particles according to some embodiments of the present technology.

FIG. 6A shows a Field Emission Scanning Electron Microscope image of an electrode according to some embodiments of the present technology.

FIGS. 6B and 6C show Transmission Emission Microscopy image an electrode according to some embodiments of the present technology.

FIG. 6D shows a Selected Area Electron Diffraction pattern of an electrode according to some embodiments of the present technology.

FIGS. 6E, 6F, 6G, 6H, and 6I show elemental mapping of an electrode according to some embodiments of the present technology.

FIG. 7A shows a Powder X-ray Diffraction Spectrum of both metal-sulfide particles and an electrode according to some embodiments of the present technology.

FIG. 7B shows a Raman spectrum of both metal-sulfide particles and an electrode according to some embodiments of the present technology.

FIG. 8A shows cyclic voltammetry curves of an electrode according to some embodiments of the present technology.

FIG. 8B shows cyclic voltammetry curves of both metal-sulfide particles and an electrode according to some embodiments of the present technology.

FIG. 8C shows charge/discharge voltage curves of an electrode according to some embodiments of the present technology.

FIG. 8D shows cyclic stability of both metal-sulfide particles and an electrode according to some embodiments of the present technology.

FIG. 8E shows charge/discharge voltage curves of an electrode according to some embodiments of the present technology.

FIG. 8F shows a comparison of rate capability of both metal-sulfide particles and an electrode according to some embodiments of the present technology.

FIG. 9A shows the logarithmic relationship between peak current and scan rate of both metal-sulfide particles and an electrode according to some embodiments of the present technology.

FIG. 9B shows charge storage distribution of metal-sulfide particles according to some embodiments of the present technology.

FIG. 9C shows charge storage distribution of an electrode according to some embodiments of the present technology.

FIG. 10A shows the Electrochemical Active Surface Area of both metal-sulfide particles and an electrode according to some embodiments of the present technology.

FIG. 10B shows an EIS Nyquist plot of both metal-sulfide particles and an electrode according to some embodiments of the present technology.

FIG. 10C shows the contact angle of metal-sulfide particles according to some embodiments of the present technology.

FIG. 10D shows the contact angle of an electrode according to some embodiments of the present technology.

FIG. 11A shows a Rietveld refinement of metal-sulfide particles according to some embodiments of the present technology.

FIG. 11B shows a Rietveld refinement of an electrode according to some embodiments of the present technology.

FIG. 11C shows a crystal structure of metal-sulfide particles according to some embodiments of the present technology.

FIG. 11D shows refined lattice parameters of both metal-sulfide particles and an electrode according to some embodiments of the present technology.

FIGS. 12A and 12B show the lowest energy structures of metal-sulfide particles according to some embodiments of the present technology.

FIGS. 12C and 12D show the lowest energy structures of an electrode according to some embodiments of the present technology.

FIGS. 12E and 12F show the lowest energy structures of metal-sulfide particles including lithium according to some embodiments of the present technology.

FIGS. 12G and 12H show the lowest energy structures of an electrode including lithium according to some embodiments of the present technology.

FIG. 13 shows Spin-polarized Partial Density of States of an electrode according to some embodiments of the present technology.

FIG. 14A shows cyclic voltammetry curves of a lithium-ion capacitor according to some embodiments of the present technology.

FIG. 14B shows charge/discharge voltage curves of a lithium-ion capacitor according to some embodiments of the present technology.

FIG. 14C shows the specific capacitance of a lithium-ion capacitor according to some embodiments of the present technology.

FIG. 14D shows the columbic efficiency of a lithium-ion capacitor according to some embodiments of the present technology.

FIG. 15A shows a Ragone plot with corresponding power and energy density of a lithium-ion capacitor according to some embodiments of the present technology.

FIG. 15B shows an EIS Nyquist plot of a lithium-ion capacitor according to some embodiments of the present technology.

FIG. 15C shows a Bode plot of a lithium-ion capacitor according to some embodiments of the present technology.

FIG. 15D shows a capacitance retention plot of a lithium-ion capacitor according to some embodiments of the present technology.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any of the similar components having the same first reference label irrespective of the letter.

### DETAILED DESCRIPTION

While LICs exhibit combine advantages of lithium-ion batteries and supercapacitors, LICs are not without issue. In conventional LICs, electrodes often suffer from electrochemical performance issues. Conventional anode electrode materials in LICs have typically included metalloids, oxides, polyanions, and graphite. These materials are classified into three types based on the charge storage mechanism. The three types include insertion type, conversion type, and alloying type. However, each of these materials suffer from electrochemical performance issues, such as limited output voltage, low energy density, low capacity, volumetric expansion issues, and rapid capacity loss to name a few. Additionally, conventional anode electrode materials in LICs have suffered from sluggish reaction kinetics, further contributing to poor electrochemical performance.

The present technology may overcome these limitations by using metal-sulfide particles, which may be encapsulated in carbon-containing material, such as carbon nanotubes. This may facilitate synergistic effect between the metal-sulfide particles and the carbon-containing material that may overcome historical shortcomings with sulfide-based materials in energy storage systems, such as LICs. Metal-sulfides alone, while exhibiting desirable performance characteristics, has also suffered from due to volumetric expansion issues. The incorporation, and partial encapsulation, of the metal-sulfides by carbon-containing material has modified the structural architecture of the metal-sulfide material, overcoming conventional issues with volumetric expansion while maintaining the desirable performance characteristics. It is understood that the present technology is not intended to be limited to the specific electrodes and processing being discussed, as the techniques described may be used to improve a number of energy storage system formation processes, and may be applicable to a variety of operations.

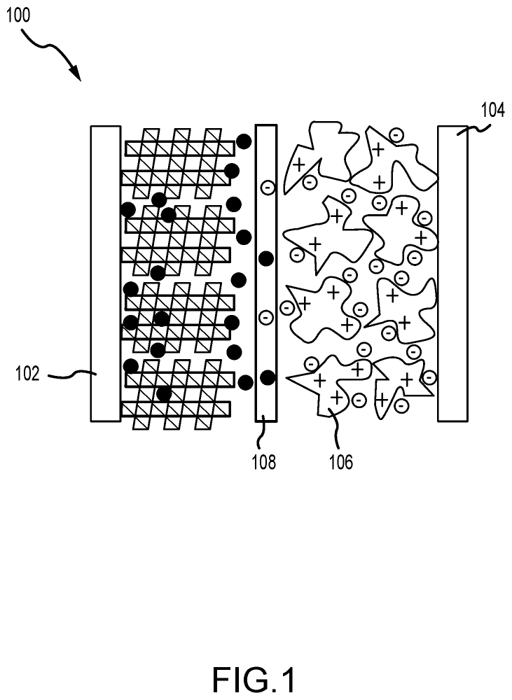

FIG. 1 shows a schematic cross-sectional view of an exemplary lithium-ion capacitor (LIC) 100 according to some embodiments of the present technology. The LIC 100 may include an anode 102. The anode 102 may be a battery-type anode, such as a lithium-ion battery anode. The LIC 100 may include a cathode 104. The cathode 104 may be a supercapacitor-type cathode, such as an electric double layer capacitor (EDLC) supercapacitive cathode. The LIC 100 may include an electrolyte 106. The electrolyte 106 may contain a lithium salt. The electrolyte 106 may be organic. A separator 108 may be positioned between the anode 102 and the cathode 104.

In operation, charges are asymmetrically and simultaneously stored in the cathode by PF₋₆ ions absorption/desorption and in the anode by Li+ intercalation/deintercalation mechanisms.

LICs 100 may combine the advantages associated with lithium-ion batteries and supercapacitors. Lithium-ion batteries may exhibit high energy density (e.g., 100-150 Wh/kg) but may possess lower power density (e.g., <10 kW/Kg) and/or poor cyclic stability (e.g., <1000 cycles) due to sluggish reaction kinetics in the bulk electrode material (e.g., intercalation/deintercalation). Conversely, supercapacitors, such as EDLCs, may exhibit high power density (e.g., >10 kW/Kg), high cyclic stability (e.g., >10,000 cycles) due to rapid ionic adsorption/desorption at the electrode surface, but may exhibit low energy density (e.g., 5-10 Wh/kg). LICs 100, in combining features of lithium-ion batteries and supercapacitors, may exhibit high energy density, high power density, and high cyclic stability.

The electrochemical performance of the LICs mainly depends on the properties of the anode and cathode. Various properties such as rate capacity, specific capacity, operating potential window, and cyclic stability significantly influence the performance of LICs. Recently, metal-sulfides have emerged as promising materials for lithium-ion batteries and supercapacitors. Metal-sulfides may have emerged as promising materials due to their unique properties, including, for example, low cost, high electrical conductivity, and high theoretical specific capacity. Metal-sulfides may outperform existing electrode materials for anode applications due to the redox chemistry of the metal-sulfides. Accordingly, metal-sulfides may deliver superior electrochemical performance in terms of higher energy and higher power density compared to conventional anode materials. However, metal-sulfides exhibit poor cyclic stability due to polysulfide formation, which is often referred to as “shuttle effect”. Accordingly, the application of metal-sulfides has been rather limited due to the poor cyclic stability.

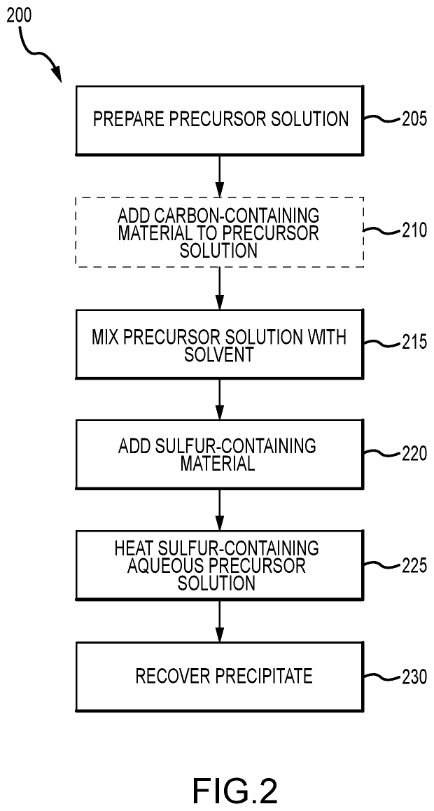

FIG. 2 shows exemplary operations in a method 200 according to some embodiments of the present technology. Method 200 may prepare metal-sulfide particles or nanospheres, which may be employed in an anode of a LIC, such as LIC 100. Method 200 may include a number of optional operations, which may or may not be specifically associated with some embodiments of methods according to the present technology. For example, many of the operations are described in order to provide a broader scope of the structural formation, but are not critical to the technology, or may be performed by alternative methodology as would be readily appreciated. Method 200 may include additional operations prior to initiation of the listed operations. For example, additional processing operations may include pre-treatments of the precursors, such as purification operations.

Method 200 may include preparing a precursor solution at operation 205. The precursor solution may include a copper-containing precursor and a metal-containing precursor. Any number of copper-containing precursor may be used with the present technology. For example, the copper-containing precursor may be or include copper halogens, such as copper chloride, copper bromide, copper fluoride, or hydrates, such as copper chloride dihydrate, copper bromide dihydrate, copper fluoride dihydrate, as well as any other copper-containing materials that may be used to produce metal-sulfide particles. Any number of metal-containing precursors may be used with the present technology. For example, the metal-containing precursor may be or include a tin-containing precursor or an iron-containing precursor, although other metals are contemplated. The tin-containing precursor may be or include tin halides, such as tin chloride, tin bromide, tin fluoride, as well as any other tin-containing materials that may be used to produce metal-sulfide particles. The iron-containing precursor may be or include iron halides, such as iron chloride, iron bromide, iron fluoride, as well as any other iron-containing materials that may be used to produce metal-sulfide particles.

In embodiments, method 200 may include adding a carbon-containing material to the precursor solution at optional operation 210. The carbon-containing material may be added to the precursor solution, or components of the precursor solution may be added to the carbon-containing material. The carbon-containing material may be or include carbon nanotube or graphene. The carbon-containing material and the precursor solution may be mixed for a period of time prior to proceeding to operation 215. By mixing for the period of time, the precursor solution may become at least partially encapsulated by the carbon-containing material. The carbon-containing material may form a carbon matrix. The carbon matrix may buffer the volume expansion and may provide anchoring sites for polysulfides, resulting in improvement in the cyclic stability of the anode. The encapsulation may also enhance the electrical conductivity and provide for efficient charge transfer, improving the rate capability and specific capacity of the electrode.

Method 200 may include mixing the precursor solution with a solvent, such as water, to form an aqueous precursor solution at operation 215. In embodiments, the precursor solution may be mixed with deionized water. The precursor solution and the water may be mixed at any temperature, such as room temperature (i.e., ambient conditions). After the aqueous precursor solution is formed, the solution may be mixed such that the precursors in the precursor solution are at least partially or fully dissolved in the water. In one embodiment, the aqueous precursor solution may include between about 0.05 M and about 0.35 M CuCl₂H₄O₂ and between about 0.05 M and about 0.20 M SnCl₄.

Method 200 may include adding a sulfur-containing precursor to the aqueous precursor solution to form a sulfur-containing aqueous precursor solution at operation 220. Any number of sulfur-containing precursor may be used with the present technology. For example, the sulfur-containing precursor may be or thiourea (SC(NH₂)₂), as well as any other sulfur-containing materials that may be used to produce metal-sulfide particles.

Method 200 may include heating the sulfur-containing aqueous precursor solution at operation 225. The sulfur-containing aqueous precursor solution may be heated to greater than or about 120° C., such as greater than or about 130° C., greater than or about 140° C., greater than or about 150° C., greater than or about 160° C., greater than or about 170° C., greater than or about 180° C., greater than or about 190° C., greater than or about 200° C., or more.

In embodiments, method 200 may include adding a lanthanum-containing precursor, a samarium-containing precursor, or a combination thereof to the precursor solution, the aqueous precursor solution, or the sulfur-containing aqueous precursor solution. Elements with high atomic numbers, such as greater than 50, may be added to the precursor solution, the aqueous precursor solution, or the sulfur-containing aqueous precursor solution. The incorporation of these elements may dope the metal-sulfide particles. The elements with high atomic numbers may increase the overall crystal structure volume. Increased crystal structure volume may promote high charge accumulation and ease the lithium intercalation/deintercalation mechanism. Even after doping, ternary elements may be present in the particles, which may promote rich redox activity, resulting in increased electrical conductivity. The rich redox activity may also enhance specific capacity and/or rate capability.

In embodiments, method 200 may include placing a graphite paper substrate in the precursor solution, the aqueous precursor solution, or the sulfur-containing precursor solution. By introducing the graphite paper substrate prior to the initiation of the reaction, the metal-sulfide particles may be formed without a binder. By forming the metal-sulfide particles without a binder, electrical conductivity in subsequently formed electrodes may be increased, thereby increasing performance of the electrode.

Method 200 may include recovering a precipitate from the sulfur-containing aqueous precursor solution at operation 230. The precipitate may be or include metal-sulfide particles. The precipitate may be recovered by centrifuge. The precipitate may be washed with deionized water and ethanol. The precipitate may then be vacuum dried. Depending on the metal-containing precursor used in operation 205, the precipitate may include Cu₂SnS₃ (CTS) in the case of a tin-containing precursor, or CuFeS₂ (CFS) in the case of an iron-containing precursor.

CTS and CFS may overcome the issues associated with metal-sulfides, including poor cyclic stability due to polysulfide formation. Copper, iron, and/or tin are strong thiophilic elements which may promote sulfur fixation. The sulfur fixation may reduce the amount of polysulfide formation that may occur. Due to the inclusion of copper, iron, and/or tin in the anode, polysulfide formation may be reduced or prevented and, therefore, cyclic stability may be improved. Furthermore, the materials used to form CTS and CFS are earth-abundant, cost-effective and non-toxic elements. CTS and CFS may be synthesized using various physical and chemical techniques. Surface area can be easily varied by controlling the morphology (e.g., spherical and pyramidal nanocrystallites, nanowires, hexagonal ‘plate’, and spike-like ‘nanorods’). The three-dimensional (3D) morphology, which may be porous, may provide active sites for ionic interaction. The porous morphology may provide efficient ionic transport paths, resulting in improved specific capacity and/or rate capability. CTS and CFS are characterized by high electrical conductivity and high theoretical specific capacity (e.g., 680 and 583 mAh/g for CTS and CFS, respectively). Finally, CTS and CFS both include the low electronegativity of sulfur, enabling the sulfur to replace oxygen and form compounds with improved ionic diffusivity, highly suitable for electrochemical applications.

A lithium-ion anode, such as the anode 102 shown in FIG. 1 may include metal-sulfide particles. The metal-sulfide particles may be similar or the same as the metal-sulfide particles formed by method 200. For example, the metal-sulfide particles may include one or more of copper, tin, or iron. In one exemplary embodiment, the metal-sulfide particles may include copper, tin, and sulfur. The metal-sulfide particles may include between about 20 at. % and about 40 at. % copper, between about 5 at. % and about 25 at. % tin, and between about 40 at. % and about 70 at. % sulfur. For example, the metal-sulfide particles may be Cu₂SnS₃ particles.

In embodiments, the metal-sulfide particles may be at least partially encapsulated by a carbon-containing material. The carbon-containing material may be or include carbon nanotubes or graphene. As further described herein, the carbon-containing material may buffer volume expansion of the metal-sulfide particles, provide anchoring sites for polysulfide ions, and allowing easy Li-ion intercalation/de-intercalation.

In embodiments, the metal-sulfide particles may be doped with one or more elements characterized by an atomic number of greater than 50. For example, the metal-sulfide particles may be doped with lanthanum, samarium, or any other element characterized by an atomic number of greater than 50. As previously discussed with regard to method 200, elements with high atomic numbers may increase the overall crystal structure volume. Increased crystal structure volume may promote high charge accumulation and ease the lithium intercalation/deintercalation mechanism. Even after doping, ternary elements may be present in the particles, which may promote rich redox activity, resulting in increased electrical conductivity. The rich redox activity may also enhance specific capacity and/or rate capability.

The lithium-ion anode may include a 3D structure having a porous morphology. The 3D structure may provide active sites for ionic interaction. The porous morphology may provide efficient ionic transport paths, resulting in improved specific capacity and/or rate capability.

A LIC, such as LIC 100 shown in FIG. 1, may include metal-sulfide particles and/or an anode as previously discussed. For example, a LIC may include a cathode, an anode, and an electrolyte. The anode may include metal-sulfide particles that are at least partially encapsulated by a carbon-containing material, such as the metal-sulfide particles previously discussed. In embodiments, the cathode may be any cathode. In embodiments, the cathode may be or include activated carbon. The electrolyte may be any electrolyte. In embodiments, the electrolyte may include ethylene carbonate and diethyl carbonate. In embodiments, the electrolyte may also include a lithium-containing material, such as lithium hexafluorophosphate. The LIC may include a separator between the cathode and the anode. In embodiments, the separator may be a polypropylene membrane. A surface of the anode may be characterized by nanospheres ranging in size between about 10 nm and about 75 nm, such as between about 10 nm and about 60 nm, between about 10 nm and 50 nm, or between about 30 nm and about 50 nm. The cathode, the anode, or both may be formed free of a binder material. As previously discussed, the anode may be doped with one or more elements characterized by an atomic number of greater than 50.

### Experimental Section

To prepare the metal-sulfide particles, tin chloride (SnCl₄), copper chloride dihydrate (CuCl₂ 2H₂O), and thiourea (CH₄N₂S) were purchased from Sigma Aldrich, United Arab Emirates, and were used without any further purification. Activated carbon, carbon nanotubes, and graphite paper were procured from Alpha Aser, South Korea.

The metal-sulfide nanostructures were obtained using a binder-free single-step hydrothermal method. In the synthesis of the metal-sulfide nanostructures, 0.2 M CuCl₂ 2H₂O and 0.12 M SnCl₄ were added to 80 mL deionized water and stirred continuously for 30 min. Then, 0.35 M CH₄N₂S was added dropwise to the solution and mixed using a magnetic stirrer for one hour until the precursor solution became colorless. The solution was then transferred to a 100 mL Teflon-lined stainless steel autoclave and heated at 180° C. for twelve hours. After the reaction, the autoclave was cooled down to room temperature. The obtained product was centrifuged and washed with multiple baths of deionized water and ethanol followed by vacuum drying at 60° C. for four hours. The metal-sulfide/carbon nanotubes composite were synthesized in the same manner as discussed above except 20 mg carbon nanotubes were mixed with the precursor solution for one hour before the start of the reaction. For obtaining binder-free coating, a graphite paper substrate was placed in the prepared precursor solution before the initiation of the reaction. The obtained product was further used for characterization and electrochemical application without any further chemical treatments.

The metal-sulfide and the metal-sulfide/carbon nanotubes nanostructures were characterized using various comprehensive characterization techniques. The surface texture, morphology, and the elemental composition of the obtained nanostructures were characterized using a field emission scanning electron microscope (FE-SEM Model: JSM-6701F, JEOL, Japan) attached with an energy-dispersive X-ray spectroscopy (EDS). A high-resolution JEOL-3010 microscope was used to obtain high-resolution transmission electron microscopy (HR-TEM) images. The structural analysis was studied using a high-resolution powder X-ray diffraction (PXRD) with Ni-filtered CuKα radiation (λ=1.54056 Å) (X-pert PRO, Philips, Eindhoven, the Netherlands) and a Raman scattering spectroscopy with a Jobin-Yvon T6400 Raman scattering system with an Olympus microscope. The excitation source of the Raman spectroscopy was an Ar ion laser operating at a wavelength of 532 nm and an output power of 220 mW. The chemical properties of the nanostructures were studied using X-ray photoelectron spectroscopy (XPS, VG Multilab 2000, Thermo VG Scientific. UK) with a monochromatic Mg-Ka (1253.6 eV) radiation source. The surface-tension of the nanostructures was analyzed using a contact angle meter (Rame-hart USA equipment) coupled with a charge-coupled device (CCD) camera.

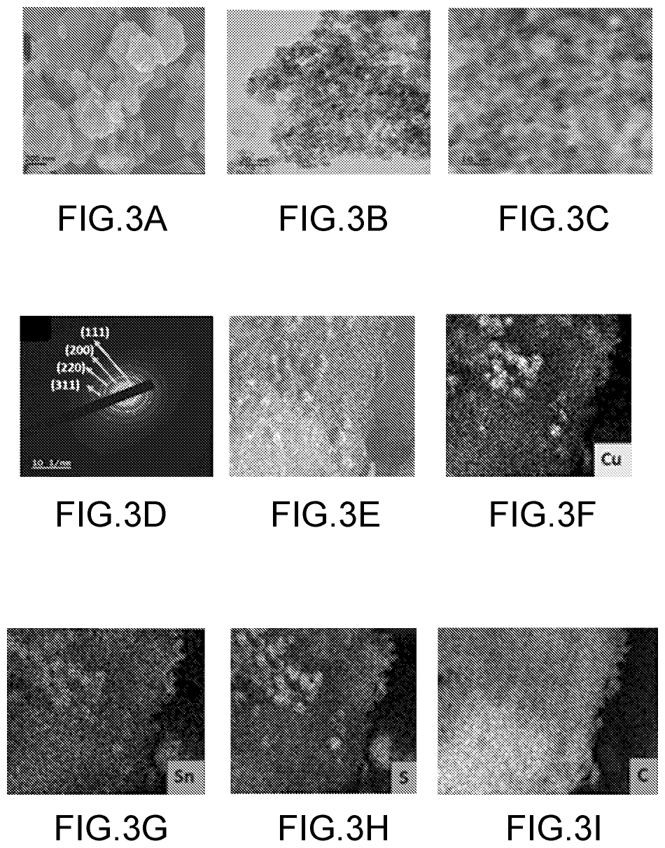

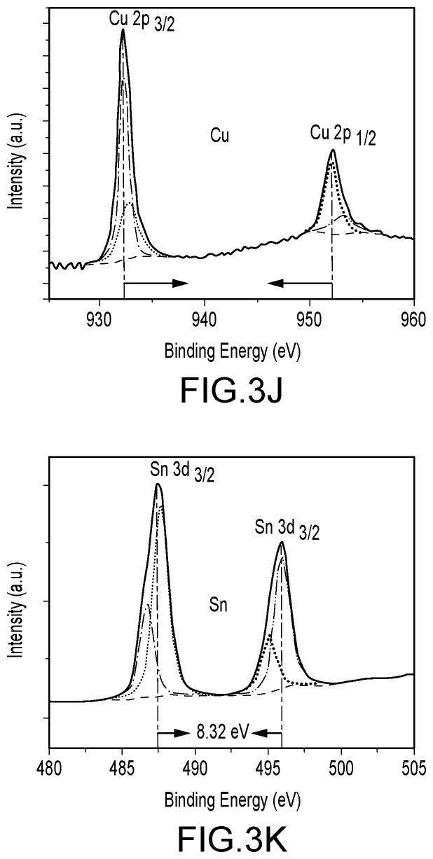

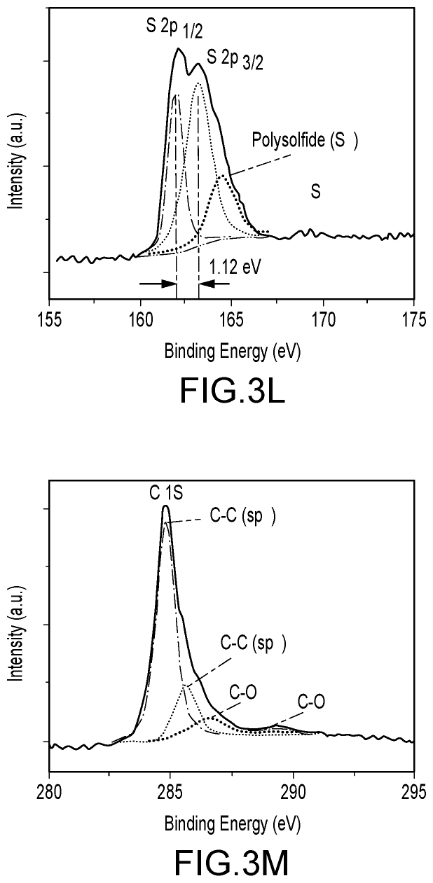

FIG. 3A shows a FE-SEM image of the metal-sulfide/carbon nanotubes electrode. As shown, the electrode exhibits spherical shaped 3D structured ‘flake-like’ morphology. FIG. 3B depicts a Transmission Emission Microscopy (TEM) image exhibiting the spherical shape interconnected nanoparticles of the electrode material in the size ranging between 5 nm and 10 nm. As shown in the TEM image of FIG. 3C, the presence of dark and bright regions in the high magnification indicate the porous nature of the fabricated electrode material with nanochannels. The Selected Area Electron Diffraction (SAED) pattern in FIG. 3D shows the presence of visible concentric rings indexed to (111), (200), (220) and (311) planes, thereby reflecting the polycrystalline nature of the electrode material. FIGS. 3E-3I show the elemental mapping of the metal-sulfide and the metal-sulfide/carbon nanotubes. FIGS. 3E-3I depict the uniform distribution of Cu, Sn, S and C elements throughout the surface/periphery. The obtained mapping intensities of Cu, Sn and S are lower than the mapping intensity of the C due to the encapsulation effect of the carbon nanotubes. Elemental quantitative analysis obtained using Energy Dispersive Spectroscopy (EDS) indicates the formation of stoichiometric carbon-tin-sulfide nanostructures at a ratio of 2:1:3, respectively. The structures include 32 at. % Cu, 14 at. % Sn, and 54 at. % S (54 at %). The slightly rich Cu discrepancy relative to the Sn in the elemental composition is attributed to the discrete chemical reactivity of the metallic precursors. The discrepancy can be explained based on the principle of hard and soft acid and bases (HSAB) where soft acid (Cu) preferentially reacts with soft base(S) rather than hard acid (Sn) reaction with soft base(S). FIGS. 3J-3M show the XPS spectra of Cu 2p, Sn 3d, S 2p, and C 1s, respectively. The X-ray Photoelectron Spectroscopy (XPS) spectra were deconvoluted using Vigot's curve fitting which resulted in perfect curve fitting for two peaks of Cu, Sn, S, and a single peak of C thereby indicating the existence of Cu in 1⁺, Sn in 4⁺, S in 2⁻ oxidation and C in Sp² hybridized state.

CR2032 lithium-ion half-cells were assembled in an Ar-filled glow box in a two electrode system configuration consisting of Li metal foil as the counter electrode and the obtained nanostructures (metal-sulfide and metal-sulfide/carbon nanotubes) as the working electrode. The mass of the active material on the working electrode was about 1 mg. The electrolyte included 1 M lithium hexafluorophosphate (LiPF₆) dissolved in a mixture of ethylene carbonate (EC)/diethyl carbonate (DC) (1:1 in volume). A polypropylene membrane (Celgard-2300) was used as the separator.

A LIC device was formed using the metal-sulfide and metal-sulfide/carbon nanotubes as the anode and activated carbon as the cathode. The LIC device was fabricated in CR2032 coin cells using 1M LiPF6 (EC/DC: 1:1) as the electrolyte and a polypropylene membrane (Celgard-2300) as the separator. As the specific capacity of the electrodes is different, the kinetic charge was balanced by optimizing the mass ratio of the anode/cathode. The mass balancing was achieved using the equation: Q+=Q−(Q=C×V×m), where C, V, and m are the capacitance, operating voltage, and mass of the active material, respectively. Based on this, the mass ratio of anode/cathode in the current work was optimized as 1:5.

The electrochemical analysis of the fabricated cells was conducted under ambient conditions. Various electrochemical studies such as cyclic voltammetry (CV), galvanostatic charge-discharge (GCD), cyclic stability, and electrochemical impedance spectroscopy (EIS) were conducted using a BioLogic VMP3 potentiostat and a Gelon battery tester (BTS 4000). The EIS was conducted in the frequency range of 0.01 Hz-100 KHz at an amplitude of 5 mV. The specific capacitance (Cs), energy density (E), and power density (P) of the LIC device was calculated from the GCD analysis using the following equations, where the discharging time is measured in seconds(s), E is the energy density and P is the power density.

$$\begin{matrix}{C}_{s} = \frac{I \times {T}_{S}}{( {V}_{2} - {V}_{1} ) \times m} & ( 1 ) \\ E = \frac{0.5 \times {C}_{S} \times {( {V}_{2} - {V}_{1} )}^{2}}{3.6} & ( 2 ) \\ P = \frac{E \times 3600}{{T}_{d}} & ( 3 )\end{matrix}$$

### Analysis

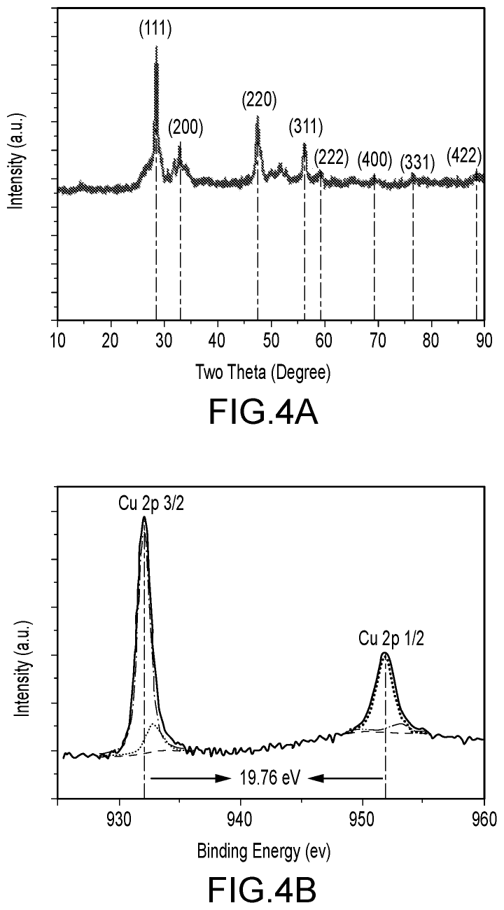

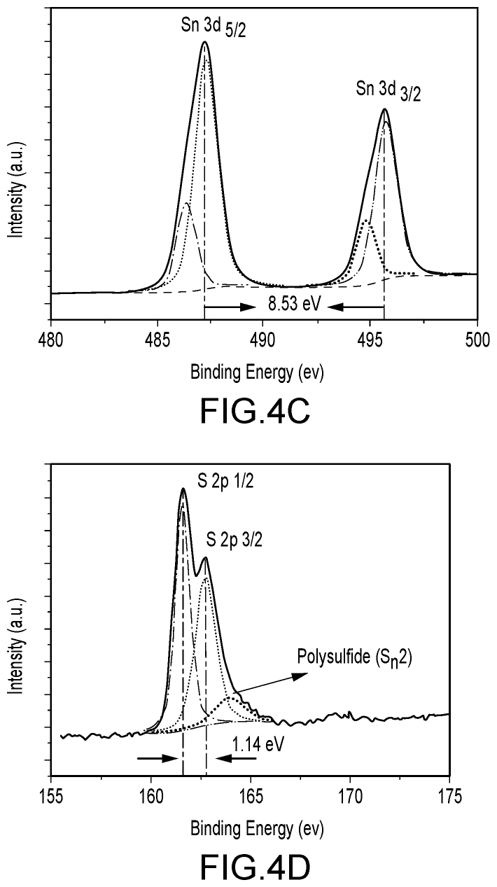

The crystal structure of the fabricated metal-sulfide particles was confirmed by PXRD. The PXRD spectrum in FIG. 4A reveals the crystalline structure of the metal-sulfide particles as diffraction peaks at 2θ=28.46°, 32.76°, 47.25°, 56.09°, 59.13°, 69.10°, 76.24°, and 88.41° are visible. These diffraction peaks correspond to the (111), (200), (220), (311), (222), (400), (331), and (422) lattice planes of the cubic structured metal-sulfide particles (F-43m space symmetry) with the preferred growth orientation along (111) plane. No other peaks corresponding to the secondary phases (CuS, Cu₂S, SnS, and SnS₂) are observed indicating phase pure synthesis of the metal-sulfide particles. The chemical states of the constituent elements in the metal-sulfide particles were determined from the XPS study. FIGS. 4B-4D depict the XPS spectra of Cu 2p, Sn 3d, and S 2p, respectively. To precisely evaluate the chemical states, the curves were deconvoluted using Voigt's curve fitting that resulted in the perfect curve fitting for the two peaks of Cu, Sn, and S. As shown in FIG. 4B, the peaks present at the binding energies of 951.92 eV and 932.16 eV corresponding to the energy core levels of Cu 2p1/2 and Cu 2p3/2, respectively, with an energy difference of 19.76 eV indicates the existence of Cu in Cu⁺ state. Generally, Cu exists in multiple states (Cu⁺ and Cu²⁺) in sulfide based compounds. However, the shake-up peak at 942 eV corresponding to the Cu²⁺ state of the Cu as well the satellite peak of CuO at higher binding energy is absent, indicating the existence of Cu in an exclusively single oxidation state (Cu⁺). The single oxidation state of Cu is highly desirable in electrochemical applications as it forms stable bonds with the constituent atoms thereby providing stable structural architecture against polarization effect. The peaks at the binding energies of 495.75 eV and 487.22 eV in FIG. 4C correspond to the energy core levels of Sn 3d3/2 and Sn 3d5/2, respectively. The energy gap difference of 8.53 eV between these core levels signifies the presence of Sn in the Sn⁴⁺ state. As shown in FIG. 4D, the S features a double-peak nature with the peaks located at 162.76 eV and 161.62 eV corresponding to the energy core levels of S 2p3/2 and S 2p1/2 with the energy difference of 1.14 eV indicates the existence of S in S²⁻ state. Furthermore, the absence of peaks around 167.5 eV and 169 eV signifies the purity of the sample from the surface contamination and the local surface oxidation, respectively. Thus, summarizing the XPS results, the oxidation states of the Cu, Sn, and S are identified as 1⁺, 4⁺, and 2⁻, respectively. The existence of such multiple oxidation states is highly favorable in energy storage systems as it enhances the redox activity for improved charge storage capabilities.

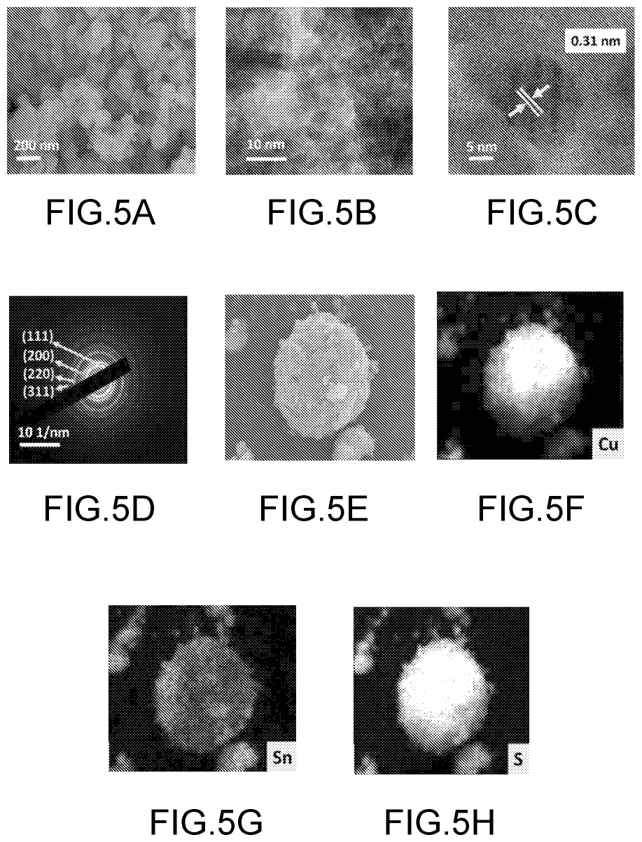

The surface morphology of the metal-sulfide particles was visualized by FESEM. The FESEM image shown in FIG. 5A indicates the formation of densely packed nanospheres in the size ranging of 20-50 nm. The nanospheres exhibit rough texture and are composed of unevenly assembled nanoflakes. The nanospheres are well connected to form a hierarchical porous network. Such type of porous morphology is beneficial as it provides numerous electroactive sites for efficient charge storage. In addition, the smaller nanospheres are aggregated to form larger entities and can be explained based on the chemical reactivity of the precursors. As the hydrothermal reaction proceeds, the thiourea undergoes hydrolysis realizing OH ions. This may raise the pH of the solution, thereby raising its overall chemical reactivity. Moreover, the employed chloride precursor sources (CuCl₂ and SnCl₄) are highly reactive. Thus, the combination of such highly reactive precursor sources results in chemical reactions at an uncontrolled rate with the nucleation and the grain growth mechanisms occurring simultaneously. The newly formed nuclei absorb the generated monomers and grow rapidly and freely in all the possible directions. As a result, the grain growth rate may exceed the nucleation rate, and thus unstable particles with high surface energy may be formed. To stabilize, these particles lower their surface energy by reducing their surface area by merging with the neighboring particles (aggregation). Thus, by closely controlling the reactivity of the precursors, the morphology of the formed particles may be controlled. As shown in the high magnification TEM image of the metal-sulfide particles in FIG. 5B, interconnected ‘web-like morphology’ structure with slight aggregation is clear. In addition, the dark and bright patterns in the TEM image also reveals the formation of dense and porous morphology, respectively. The formation of such unique morphology is highly beneficial as the interconnected structure provides efficient charge transfer paths while the porous morphology provides high-density electroactive sites for efficient charge storage. The HRTEM image in FIG. 5C shows the lattice fringes with an interplanar distance of 0.31 Å that corresponds to the (111) crystallographic plane of the cubic structured metal-sulfide particles. Furthermore, the selected area electron diffraction (SAED) pattern image shown in FIG. 5D confirms the polycrystalline nature of the fabricated metal-sulfide particles as the concentric rings corresponding to the (111), (200), (220), and (311) crystallographic planes are observed. The elemental mapping images of the metal-sulfide nanostructures showed in FIGS. 5E-5H reveal the uniform distribution of the constituent elements (Cu, Sn, and S) throughout the surface of the metal-sulfide particles in the ideal stoichiometric ratio of 2:1:3, respectively. The obtained EDS values represent the existence of Cu (32.97 at %), Sn (14.66 at %), and S (52.37 at %) with slightly Sn poor composition. The slight compositional inhomogeneity is attributed to the different chemical reactivity of the metallic precursors (Cu and Sn) and can be explained on the principle of hard and soft acid bases (HSAB). As per the HSAB principle, the reaction between soft acid (Cu) with soft base (S) is more preferred than the reaction between hard acid (Sn) with soft base (S).

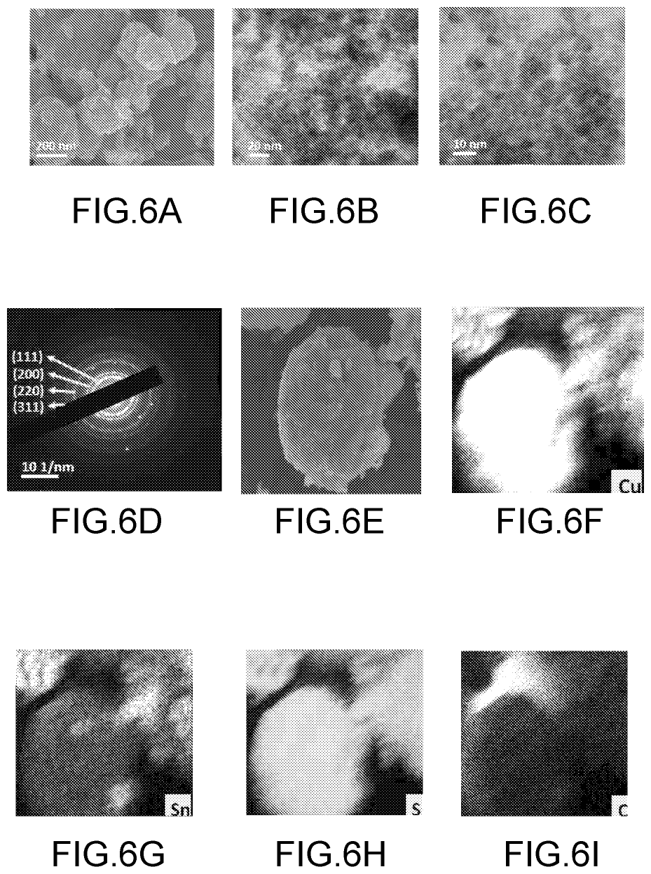

As previously discussed, the metal-sulfide/carbon nanotubes composite was obtained by direct mixing and reacting the precursor solution with the carbon nanotubes. FIG. 6A depicts the FESEM image of the metal-sulfide/carbon nanotubes composite. The obtained composite exhibits a very distinctive morphology as compared to the pristine metal-sulfide particles. The composite exhibits a smooth textured surface with closed ‘sphere-like’ morphology in which the metal-sulfide particles are encapsulated by the carbon nanotubes. Such encapsulation may promote fast Li-ion intercalation/deintercalation into/from metal-sulfide particles and buffer volume changes resulting in improved rate capability and cyclic stability. The formation of such morphology may be accomplished in two steps. In the first step, the metal precursors may react and form hierarchical porous nanospheres. Simultaneously, due to extreme reaction conditions (high temperature and high pressure), the carbon nanotubes may merge and agglomerate. In the second step, the carbon nanotubes may interact with the previously formed metal-sulfide particles, and encapsulate the metal-sulfide particles as the reaction proceeds. It should be noted that the carbon nanotubes do not interfere in the growth formation of metal-sulfide particles as the spherical shaped morphology similar to that of pristine metal-sulfide particles is observed. No separate morphologies of carbon nanotubes (1D tubes) and/or metal-sulfide particles (3D spheres) are visible in the FESEM image implying the complete and uniform encapsulation of the metal-sulfide particles by the carbon nanotubes. Furthermore, the high magnification TEM images in FIGS. 6B-6C also confirm the existence of the porous structured metal-sulfide/carbon nanotubes composite with the reduced particle size (e.g., 10-30 nm). The visible concentric rings in the SAED pattern image in FIG. 6D, and the elemental mapping shown in FIGS. 6E-6I also acknowledge the polycrystalline nature of the metal-sulfide/carbon nanotubes composite with a homogeneous distribution of Cu, Sn, S, and C on its surface.

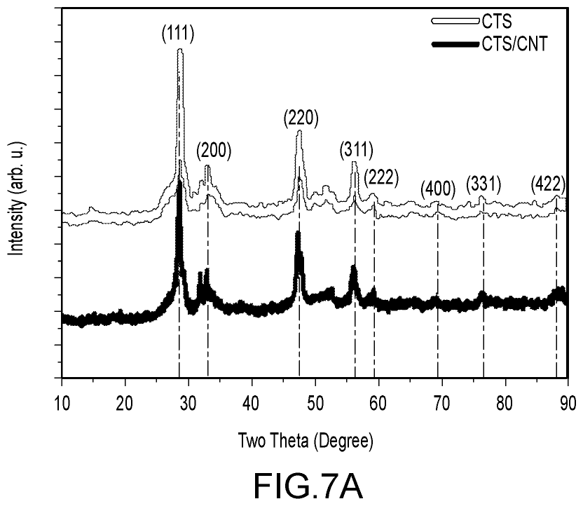

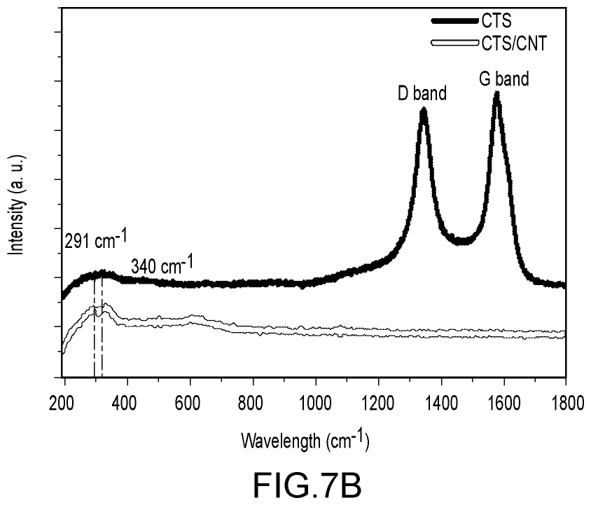

The PXRD spectrum of the metal-sulfide/carbon nanotubes composite is shown in FIG. 7A. The diffraction peaks of the metal-sulfide/carbon nanotubes composite match exactly with that of the metal-sulfide particles indicating its crystalline nature with preferred growth orientation along the (111) plane of the cubic structure. A slight difference in the diffraction peak positions and their intensities are observed. The peaks are shifted to the lower diffraction angles (2θ) and the intensities are slightly reduced. These effects are attributed to the amorphous nature and the encapsulation of the carbon nanotubes. Additionally, to confirm the crystal structure as well as the encapsulation by the carbon nanotubes, Raman analysis was conducted. As shown in FIG. 7B, the Raman spectra of the pristine carbon nanotubes exhibits two characteristic peaks located at 291 and 340 cm⁻¹ corresponding to the A₁ mode vibrations of the cubic structure. The absence of peaks corresponding to the secondary phases of SnS (221 cm⁻¹) and CuS (470 cm⁻¹) affirms the phase pure nature, and is consistent with the result from XRD analysis. The metal-sulfide/carbon nanotubes composite exhibits a similar Raman spectrum as that of the pristine metal-sulfide particles. The characteristic peak intensities (291 cm⁻¹ and 340 cm⁻¹) corresponding to the lattice vibrations of the cubic structured metal-sulfide particles are reduced. The prominent peaks corresponding to the lattice vibrations of the carbon nanotubes are visible (D band mode at 1347 cm⁻¹ and G band mode at 1577 cm⁻¹). The co-existence of these peaks in the single Raman spectra confirm the encapsulation of carbon nanotubes on the metal-sulfide particles. The studies dictate the formation of pure phase of metal-sulfide/carbon nanotubes composite with the desired properties highly suitable for electrochemical energy storage applications.

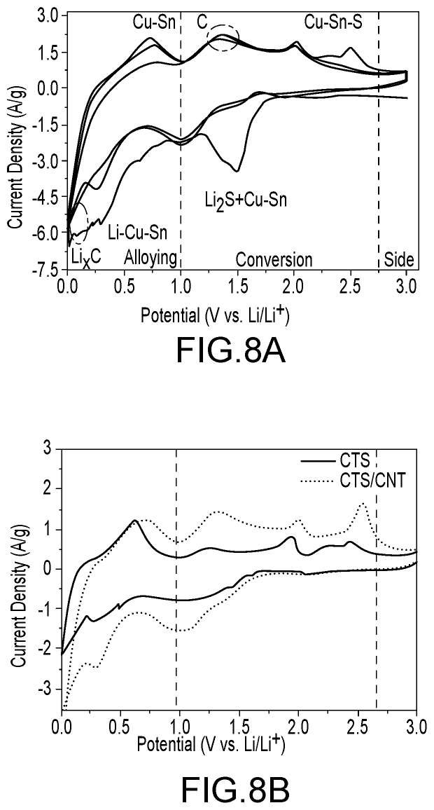

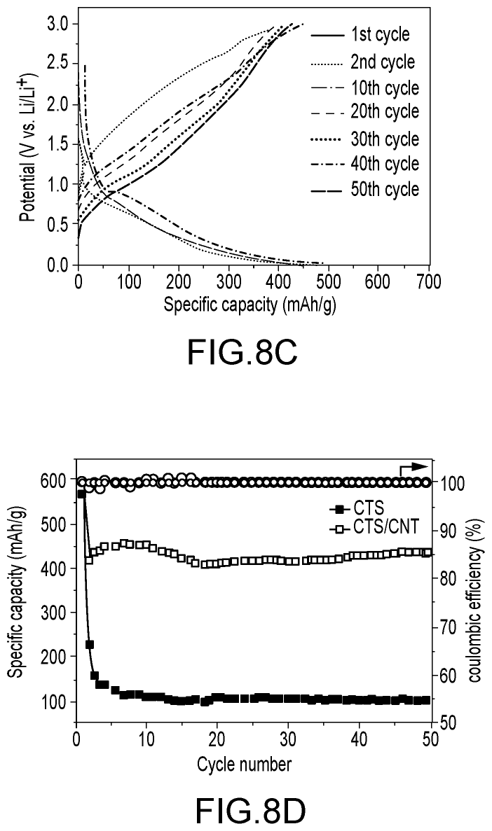

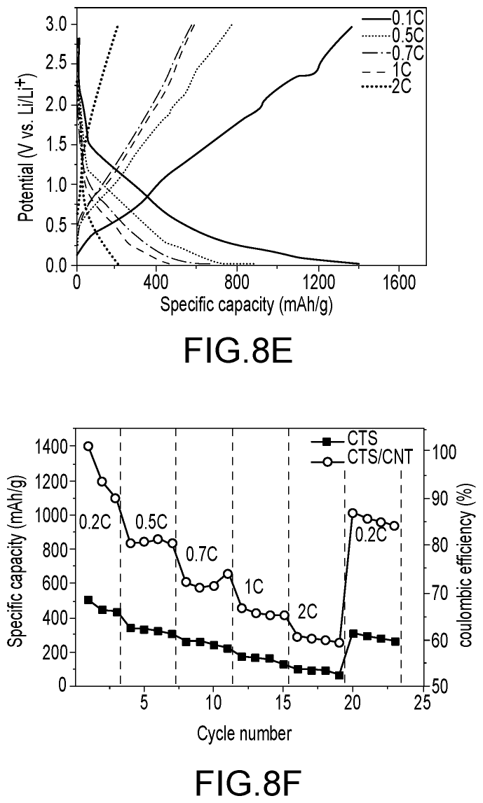

The electrochemical performance of the metal-sulfide/carbon nanotubes composite electrode was evaluated by fabricating Li-ion half cells. The cyclic voltammetry (CV) curves of the metal-sulfide/carbon nanotubes composite electrode for the first three cycles are depicted in FIG. 8A. The CV curves are recorded in the potential range of 0.01 to 3 V at a scan rate of 0.2 mV/s. In the first cathodic cycle, the peaks at 2.2 V, 1.48 V, and 1.3 V are attributed to the formation of solid electrolyte interphase (SEI) and the multistep conversion of metal-sulfide particles into metallic Cu, Sn, and amorphous Li₂S, respectively. With further scanning to the lower potential region, the broad reduction peaks present in the voltage range of 0.7 to 0.01 V are due to the intercalation of Li-ion into the carbon matrix of the carbon nanotubes (LiₓC₆) and the alloy formation of Li-ions with Sn (LiₓSn). No peaks associated with the reaction of Cu are observed as it is electrochemically inactive in this voltage range (0.7-0.01 V). However, the physical presence of Cu enhances the overall electrical conductivity of the electrode resulting in improved rate capabilities. In the next anodic cycle, the immediate oxidation peaks around 0.55 V and 1.43 V are likely due to the de-alloying mechanism of LiₓSn and de-intercalation of Li-ions from the carbon matrix, respectively. The intensity of the de-alloying peak is reduced after subsequent cycling. Notably, the peak intensity at 1.43 V is retained at all the cycles implying that the carbon nanotubes have buffered the volume change and restored the structural integrity of the electrode. With further scan in the positive voltage direction, the multiple peaks emerge at 1.9 V and 2.4 V, and are assigned to the regeneration of metal-sulfide particles and the oxidation of Li₂S, respectively. In the subsequent cycles, the Li₂S oxidation peak intensity is reduced and slightly shifted to the lower potential due to irreversible reactions with the electrolyte. However, the metal-sulfide particles regeneration peak maintains intensity and position at all the cycles indicating the superior reversible capacity of the electrodes. Beyond 2.75 V, no peaks corresponding to the undesired ‘side-reactions’ are observed thereby avoiding irreversible capacity loss. Additionally, the CV curves retain their shape and overlap each other indicating good cyclic stability of the electrode for reversible electrochemical processes. Thus, it can be concluded that the Li-ion charge storage in the metal-sulfide/carbon nanotubes composite electrode is governed by the conversion, insertion, and alloying mechanisms. Based on the above interpretations, the following plausible equations are proposed for Li-ion storage in the composite electrode.

$$\begin{matrix}{Cu}_{2} {Sn}_{3} + 6 {Li}^{+} + 6 {e}^{-} ↔ 2 Cu + Sn + 3 {Li}_{2} S & ( 4 ) \\ Sn + x {Li}^{+} + x {e}^{-} ↔ {Li}_{x} Sn ( 0 \leq x \leq 4.4 ) & ( 5 ) \\ 6 C + x {Li}^{+} + x {e}^{-} ↔ {Li}_{x} {C}_{6} & ( 6 )\end{matrix}$$

FIG. 8B shows the CV plot of the fabricated metal-sulfide/carbon nanotubes composite electrodes. As seen, both the electrodes exhibit a similar curve profile. Notably, the metal-sulfide/carbon nanotubes composite electrode exhibits a higher area under the CV curve as well as attains higher current density at both the cycles (anodic and cathodic) indicating its superior performance than the pristine metal-sulfide electrode. The representative charge/discharge curves of the metal-sulfide/carbon nanotubes composite electrode obtained at the current density of 1 C are shown in FIG. 8C. The composite electrode exhibits a high initial discharge capacity of 600 mAh/g. After the first cycle, the discharge capacity is reduced to 440 mAh/g. The capacity loss of 26.5% in the second discharge cycle is attributed to the SEI formation and the electrolyte decomposition. From the second charge/discharge cycle, the specific capacity slightly increases up to the 10th discharge cycle and remains stable with 452 mAh/g capacity due to electrode activation and stabilization. This feature of electrodeactivation during electrochemical cycling is well pronounced in ‘alloy-conversion’ type anode electrodes. As shown in FIG. 8D, after 50 cycles, the electrode retains a high reversible charge/discharge capacity of 444/450 mAh/g, respectively with 100% columbic efficiency and excellent cyclic stability of 107%. The enhanced performance of metal-sulfide/carbon nanotubes composite electrode is attributed to the synergistic effect where the carbon nanotubes buffer volume expansion of the metal-sulfide particles, provide anchoring sites for polysulfide ions, and allowing easy Li-ion intercalation/de-intercalation (rapid charge transfer) while the metal-sulfide particles provide numerous electroactive redox sites for efficient Li-ion interaction.

The rate capability is one of the important factors that determine the success of LIBs in commercial applications. FIGS. 8E-8F show the rate performance of the metal-sulfide particles and metal-sulfide/carbon nanotubes composite electrodes at various current densities. As shown, the metal-sulfide/carbon nanotubes composite electrode demonstrates a superb rate capability by delivering high discharge capacities of 1400 mAh/g, 858 mAh/g, 662 mAh/g, and 446 mAh/g at the applied current densities of 0.2 C, 0.5 C, 0.7 C, and 1 C, respectively. The electrode efficiently stores Li-ions and retains a substantial capacity of 288 mAh/g even at a higher current density of 2 C. Notably, the electrode also exhibits excellent charge recovery ability as it delivers 1015 mAh/g capacity when the current density was brought back to 0.2 C. As shown in FIG. 8F, a low discharge capacity of 504 mAh/g, 337 mAh/g, 257 mAh/g, 170 mAh/g, and 101 mAh/g is obtained at the applied current density of 0.2 C, 0.5 C, 0.7 C, 1 C, and 2 C, respectively. The obtained low performance signifies the sluggish reaction kinetics (alloy/de-alloy) of the electrode in absence of a highly electrically conductive carbon framework. To elucidate the electrochemical kinetics of the metal-sulfide and metal-sulfide/carbon nanotubes composite electrodes, the CV at different scan rates (e.g., 2-20 mV/s) were conducted in the similar potential window of 0 V to 3 V versus Li/Li+. The electrochemical kinetics may be determined from the following equation.

$$i = {av}^{b} \qquad ( 7 )$$

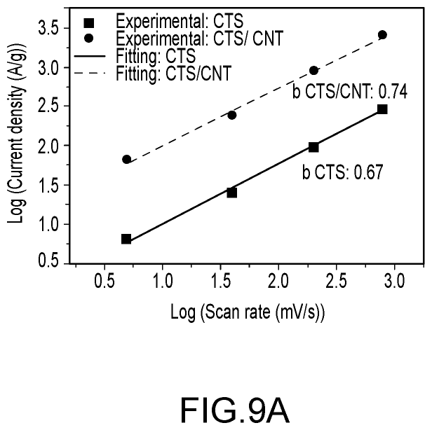

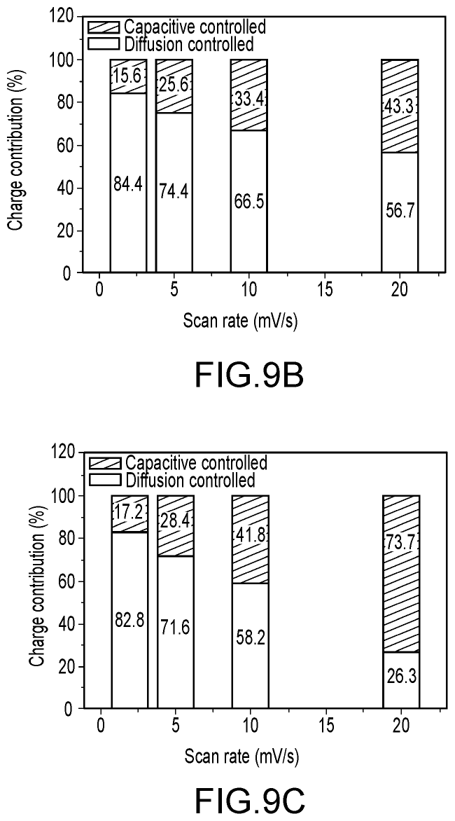

In equation (7), i is the peak current and v is the scan rate. A ‘b-value’ close to 0.5 or 1 indicates the reaction kinetics are either diffusion-controlled (redox) or surface capacitive controlled (supercapacitive). The ‘b-value’ is determined from the slope of log(i) versus log(v) in the CV curves. As shown in FIG. 9A, the pristine metal-sulfide and the metal-sulfide/carbon nanotubes composite electrode exhibits a ‘b-value’ of 0.67 and 0.74, respectively. Thus, the charge storage kinetics in the pristine metal-sulfide electrode is dominated by ‘diffusion-reaction’ and is controlled by ‘mixed-reaction’ (diffusion+surface capacitive), which may also be referred to as ‘pseudocapacitive-reaction’ in the metal-sulfide/carbon nanotubes composite electrode. The metal-sulfide particles contribute to redox activity while the carbon nanotubes contribute to capacitive activity. The synergistic effect of both results in improved electrochemical performance. Furthermore, the total current generated in the electrodes at a particular voltage may be composed of diffusion-controlled contribution (k_{1V}) and pseudocapacitive controlled contribution (k_{2V}). The total current generated in the electrodes at a particular voltage is demonstrated from the following equation.

$$I ( v ) = {k}_{1 V} + {k}_{2 V}^{1 / 2} \qquad ( 8 )$$

In equation (8), k₁ and k₂ are constants derived from the CV curves at various scan rates. The ratio of the charge contribution at varied scan rates is depicted in FIGS. 9B-9C. At a low scan rate (e.g., 2 mV/s) the electrochemical kinetics in both the electrodes is mostly ‘diffusion-controlled’ (e.g., >80%). However, as the scan rate increases (e.g., 5-20 mV/s), due to timescale limitations, the Li-ions cannot sufficiently diffuse and interact with the internal electroactive redox sites of the electrodes. As a result, the Li-ions only interact with the external electroactive sites on the surface of electrodes and generate surface capacitive charge (i.e., a pseudocapacitive charge). The pseudocapacitive charge generation becomes more prominent with the increased scan rates and is more profound in the metal-sulfide/carbon nanotubes composite electrode because of the capacitive nature of the carbon nanotubes. A high pseudocapacitive charge contribution (e.g., 73.7%) is attained in the metal-sulfide/carbon nanotubes composite electrode as compared to the pristine metal-sulfide electrode (e.g., 43.33%) at the higher scan rate of 20 mV/s. Such a high pseudocapacitive charge contribution implies rapid Li-ion storage ability at high current density.

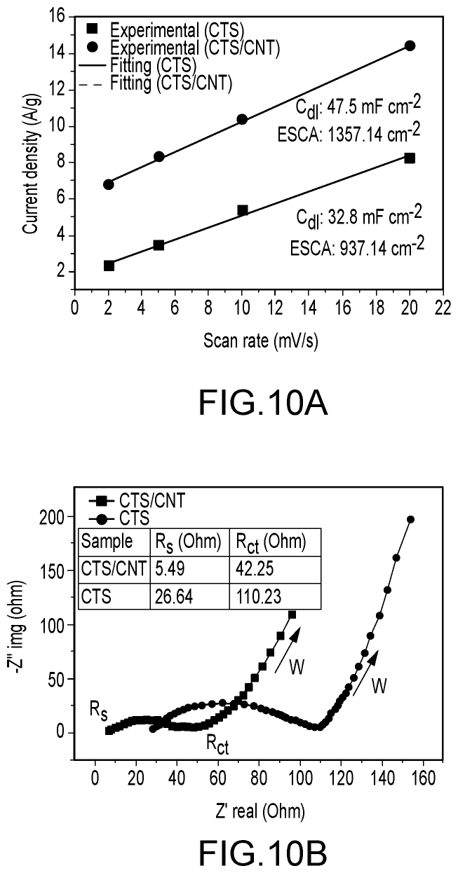

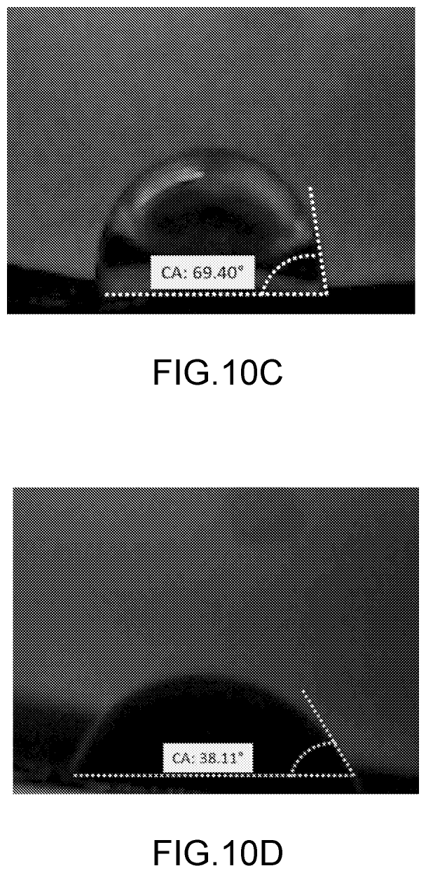

These studies certainly indicate the improved electrochemical performance of the metal-sulfide/carbon nanotubes composite electrode as compared to the pristine form (e.g., metal-sulfide electrode without carbon nanotube encapsulation) in terms of enhanced capacity, high-rate capability, and long-term cyclic stability. The obtained improved performance of the metal-sulfide/carbon nanotubes composite electrode is attributed to a number of various factors. First, the unique morphology of the metal-sulfide/carbon nanotubes composite electrode (i.e., the carbon nanotubes encapsulating the metal-sulfide nanospheres) offers numerous favorable characteristics for the electrochemical activity. The 3D structured metal-sulfide nanospheres provide high surface area electroactive sites and promote large redox activity resulting in high capacity charge generation. The flexible carbon framework offered by the carbon nanotubes significantly buffers the volume expansion of metal-sulfide nanospheres and restores cyclic stability. Such flexible carbon structure is more favorable than a rigid structure (e.g., hard carbon) as it is mechanically strong and maintains structural integrity during volumetric expansion-contraction cycles. In addition, the various functional moieties, defects, and vacancies present at the edge structures of the carbon nanotubes act as active anchoring sites for the polysulfide ions, thereby reducing or preventing the diffusion of polysulfide ions into the electrolyte. By reducing or preventing the diffusion of polysulfide ions into the electrolyte, irreversible side reactions may be minimized for higher cyclic stability. Secondly, as the particle size reduces its surface area increases. The increased surface area transcribes to higher electroactive sites, highly desirable for achieving efficient redox reactions. The metal-sulfide/carbon nanotubes composite electrode exhibits a smaller size (e.g., 10-30 nm) than its pristine form (e.g., 20-50) nm), and thus the metal-sulfide/carbon nanotubes composite electrode exhibits a higher surface area. As shown in FIG. 10A, the metal-sulfide/carbon nanotubes composite electrode exhibits a higher electrochemical active surface area (ESCA) of 1357.14 cm⁻² than the ESCA of 937.14 cm⁻² for the pristine metal-sulfide electrode. Thus, the metal-sulfide/carbon nanotubes composite electrode exhibits superior performance in terms of higher charge storage capacity (e.g., 1400 mAh/g). The ESCA is calculated by evaluating the double-layer capacitance (C_{dl}) in the non-faradic regions of the CV curves. Thirdly, as shown in FIG. 10B, the EIS Nyquist plot depicts the improved electrical and diffusion properties of the metal-sulfide/carbon nanotubes composite electrode. The high-frequency x-axis intercept with a small arc followed by a slope of the straight line in the low frequency corresponds to the series resistance (Rₛ), charge transfer resistance (R_{ct}), and Warburg resistance (W). The obtained lower values of Rₛ (5.49Ω), R_{ct} (42.25Ω), and the near 45° inclined line (W) to the vertical y-axis for the metal-sulfide/carbon nanotubes composite electrode as compared to the pristine metal-sulfide electrode (Rₛ of 26.64Ω and R_{ct} of 110.23Ω) implies high electrical conductivity, rapid redox activity at the electrode-electrolyte interface, and fast Li-ion diffusivity from the electrolyte to the electrode with reduced transport pathways. The obtained lower resistance values of the metal-sulfide/carbon nanotubes composite electrode signify improved performance in terms of enhanced rate capability. Further, as shown in FIGS. 10C-10D, the metal-sulfide/carbon nanotubes composite electrode exhibits a contact angle of 38.11°, whereas the pristine metal-sulfide electrode exhibits a contact angle of 69.40°. The contact angle of the metal-sulfide/carbon nanotubes composite electrode demonstrates a hydrophilic nature. As previously discussed, the carbon nanotubes exhibit various functional moieties at the edge structures. The functional moieties form strong bonds with the hydrogen-based groups, resulting in improved electrode-electrolyte interaction and thereby enabling maximum coverage of the electroactive sites for an efficient redox activity.

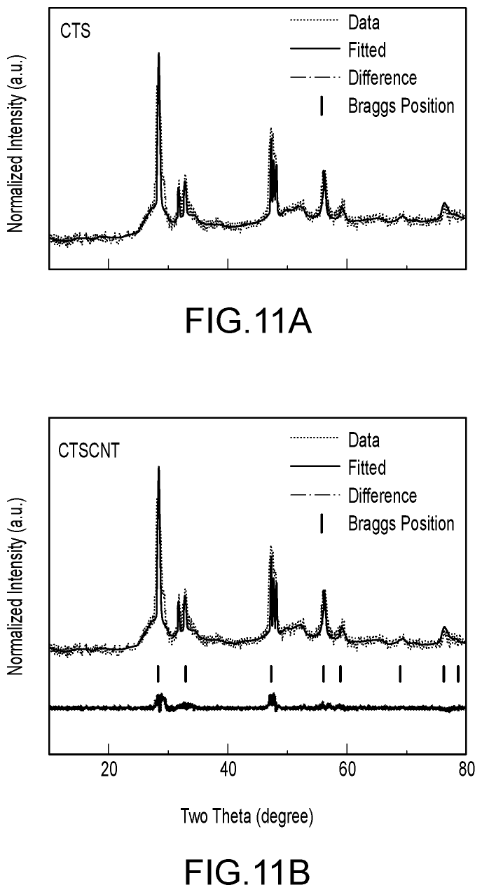

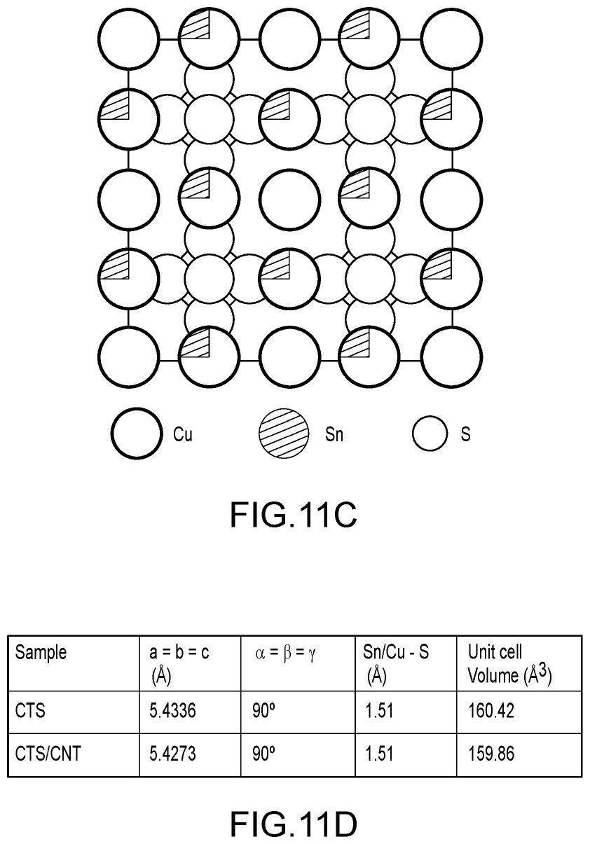

As the Li-ion storage in the electrodes is controlled by the diffusion-controlled reaction, the crystal structural properties of the electrodes may influence the electrochemical properties. The metal-sulfide/carbon nanotubes composite electrode exhibits lower XRD peak intensity than the pristine metal-sulfide form. Returning to FIG. 11A, the lower XRD peak intensity implies a lower crystalline, more amorphous nature. A lower crystalline, more amorphous material exhibits high density unsaturated electroactive sites compared to a highly crystalline counterpart. The presence of such high-density electroactive sites promotes Li-ion accommodation and charge generation, resulting in improved charge storage performance of the metal-sulfide/carbon nanotubes composite electrode. Additionally, the structural parameters are also responsible for attaining the improved electrochemical performance of the metal-sulfide/carbon nanotubes composite electrode. The structural parameters may be obtained by refining the crystal structures using Rietveld Refinement analysis. Referring to FIGS. 11A-11B, the refinement is carried on the XRD patterns of the electrodes in FULLPROF software. As shown in FIG. 11C, the corresponding structural model is visualized in VESTA. The refined structural parameters are obtained by considering fixed shape parameters values and are tabulated in FIG. 11D. Both the experimental and the calculated curves of the metal-sulfide electrode and the metal-sulfide/carbon nanotubes composite electrode match the cubic structure in the F-43m space group with a fit of 1.12 and 1.20, respectively. As shown in the structural model in FIG. 11C, the Cu, Sn, and S occupy the 4b, 4a, and 24 g sites, respectively. The S forms a polyhydric configuration while the Cu and Sn are at the equivalent positions with the occupancy of ⅔ at A site and ⅓ at B site, respectively. Furthermore, the Cu and Sn form a highly stable and consistent bonding with the S atom (Cu—S and Sn—S=1.51 [symbol] ). Such a unique configuration of Cu and Sn contributes to high structural stability with better charge storage capabilities, while the S polyhydra contributes to improved electrical conductivity. However, the S polyhydra may be more susceptible to the polarization effect and, as a result, may produce charge imbalance within the crystal structure. As a result, the polysulfide diffusion from the crystal structure into the electrolyte may lead to reduced cyclic stability. Although the polysulfide diffusion is present in both the metal-sulfide electrode and the metal-sulfide/carbon nanotubes composite electrode, polysulfide diffusion is less prominent in the composite electrode. As previously discussed, the carbon nanotube architecture provides numerous anchoring sites that may restrict the electrolytic diffusion of polysulfides. Additionally, the obtained reduced lattice parameters of the metal-sulfide/carbon nanotubes composite electrode of a=b=c of 5.4273 [symbol] and cell volume of 159.86 [symbol] , as compared to the pristine electrode of a=b=c of 5.4336 [symbol] and cell volume of 160.42 [symbol] , reflects the stable structure of the metal-sulfide/carbon nanotubes composite electrode for electrochemical activity. The reduced lattice parameters signify minimal ionic transport and charge transfer paths, thereby leading to improved charge/discharge capabilities at high current densities (i.e., rate capability). Thus, the improved structural properties of the metal-sulfide/carbon nanotubes composite electrode, such as lower particle size, lower crystallinity, and reduced lattice parameters, accompanied with unique atomic arrangement enable the metal-sulfide/carbon nanotubes composite electrode to deliver superior performance than the pristine metal-sulfide electrode form.

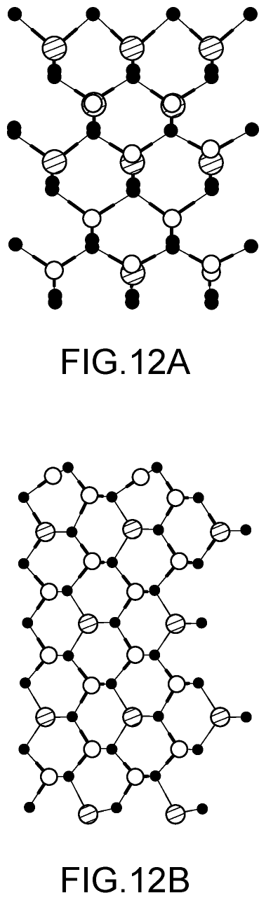

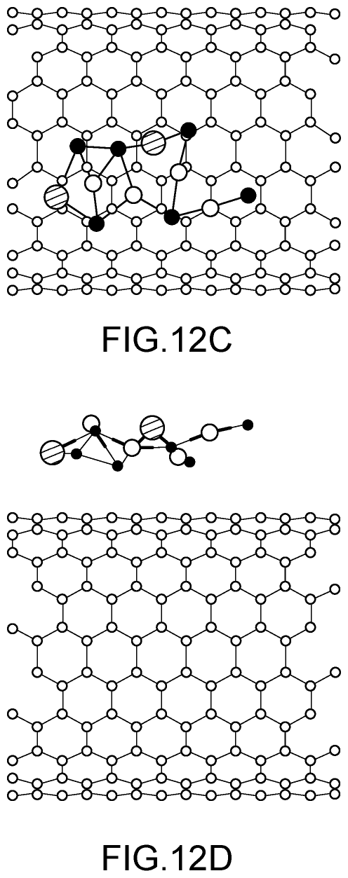

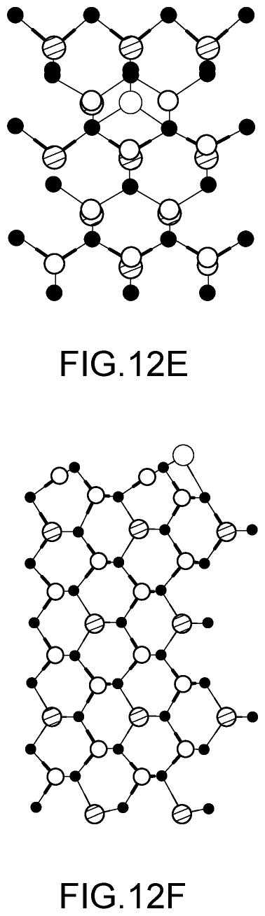

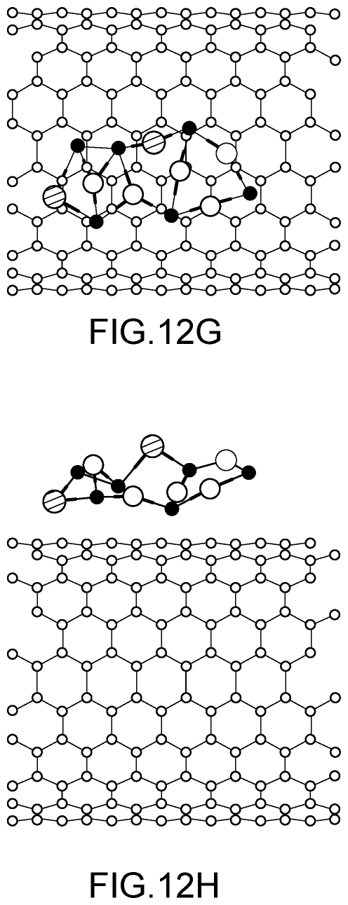

The enhanced specific capacity of the metal-sulfide/carbon nanotubes composite electrode was verified through studying binding characteristics with Li cations. As shown in FIGS. 12A-12B, the interaction of Li with the metal-sulfide nanospheres was analyzed by modeling a nine-layered surface of the metal-sulfide nanospheres along the (001) direction. Various binding sites over metal-sulfide nanospheres were considered to determine the preferred binding location of Li. As shown in FIGS. 12E-12F, the Li preferred to stabilize over the metal-sulfide nanospheres with the binding energy (E_{b}) of −3.77 eV. The optimized binding distance was 2.35 Å. The metal-sulfide/carbon nanotubes composite structure was modeled by encapsulating a small metal-sulfide cluster where Cu=4, Sn=2, and S=6 in a reasonably large carbon nanotube where C=240. As shown in FIGS. 12C-12D, the optimized structure of metal-sulfide/carbon nanotubes included lattice vectors a=b=30 Å and c=14.75 Å. Similar to the metal-sulfide nanospheres, the Li cations were introduced at various available binding sites on metal-sulfide/carbon nanotubes composite to determine the preferred binding location of Li. As shown in FIGS. 12G-12H, the lowest energy structure of Li and metal-sulfide/carbon nanotubes composite resulted in a very strong E_{b} of −5.42 eV at a binding distance of 2.27 Å. From the energetic analysis, the E_{b} values of Li were 53% stronger on the metal-sulfide/carbon nanotubes composite compared to pristine metal-sulfide electrode, demonstrating an enhanced Li storage capacity of the metal-sulfide/carbon nanotubes composite electrode. From a Bader charge analysis, the Li cation donated a higher charge of 0.995 é to the metal-sulfide/carbon nanotubes composite electrode compared to the charge of 0.895 é donated to metal-sulfide electrode.

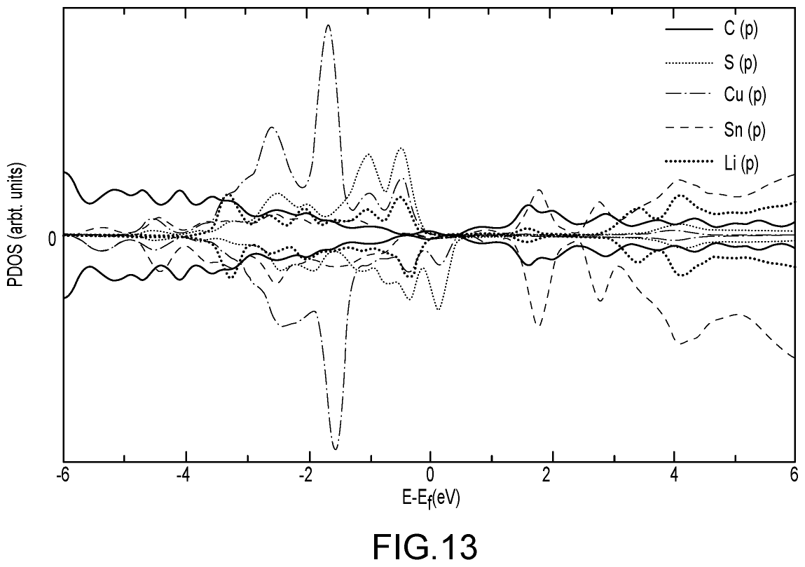

As shown in FIG. 13, the partial density states (PDOS) of the metal-sulfide/carbon nanotubes composite were plotted to gain insight into the electrical conductivity. As shown, a metallic behavior with significant contributions from Cu (d) and S (p) in the valence band region is observed, whereas the conduction band is dominated by S (p), Li(s) and Sn (d). Considerable overlap among Cu (d), S (p) and Li(s) between −0.5 eV and Fermi level on both spin-up and spin-down channels along with the pronounced peaks of Sn (d), Li(s), and C (p) at 4 eV explains the strong binding ability of the Li-ion with composite electrode.

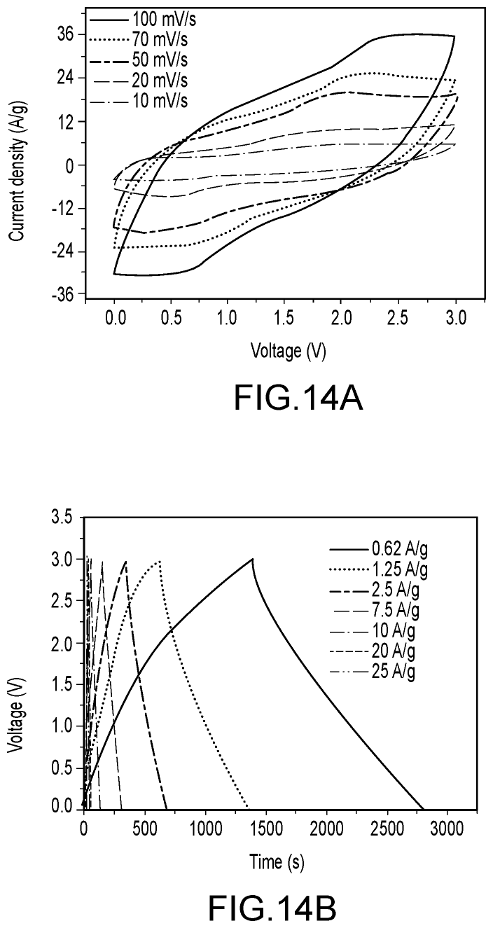

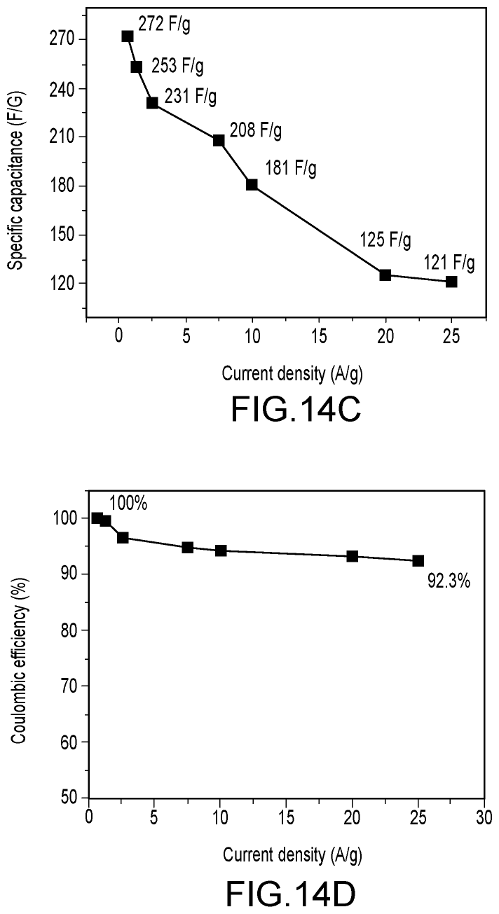

A hybrid LIC was fabricated using the metal-sulfide/carbon nanotubes composite as the anode and activated carbon as the cathode. The operating voltage range of the hybrid LIC was maintained between 0 V and 3 V as both electrodes operate in the same voltage range. The CV curves of the fabricated hybrid LIC at varied scan rates (e.g., 10-100 mV/s) are shown in FIG. 14A. The curves exhibit a quasi-rectangular shape profile with slight humps observable at all the scan rates. The proportional increment in the current density, as well as the rapid-reversible switching to anodic and cathodic cycles at different scan rates, signify ideal capacitive nature. In addition, the shift in the peak positions along with the retention of the shape of the CV curves at high scan rates indicate the absence of ‘concentration-gradient’ development within the device structure with good cyclic stability. The corresponding GCD curves of the LIC device obtained at varied current densities (e.g., 0.62-25 A/g) in the similar voltage window (e.g., 0V to 3 V) are shown in FIG. 14B. The GCD curves exhibit symmetric profile (triangular shape) at all the applied current densities indicating superior charge storage ability with faster reaction kinetics. The obtained symmetric profile implies the EDLC nature of the hybrid LIC device due to the optimized mass balance ratio of the anode/cathode. During the charge cycle, the Li⁺ and PF₆⁻ ions from the electrolyte are stored in the metal-sulfide/carbon nanotubes composite anode and the activated carbon cathode, respectively. In the discharge cycle, the ions are desorbed back into the electrolyte. As shown in FIG. 14C, based on the GCD analysis, the specific capacitance of the LIC device is obtained as 272 F/g, 253 F/g, 231 F/g, 208 F/g, 181 F/g, 125 F/g, 121 F/g at the applied current density of 0.62 A/g, 1.25 A/g, 2.5 A/g, 7.5 A/g, 10 A/g, 20 A/g, and 25 A/g, respectively. The obtained higher capacitance of 272 F/g is mostly attributed to collective electrochemical contributions of the metal-sulfide nanospheres and the carbon nanotubes as previously discussed. The gradual decrease in the capacitance with the increased scan rates is attributed mostly to timescale limitations where the electrolytic ions cannot efficiently interact with the active electrodes sites (metal-sulfide/carbon nanotubes and activated carbon). Other factors such as the ‘polarization-effect’ and the electrode's internal resistance (IR) affect the capacitive performance. As shown in FIG. 14D, the device retains nearly 45% of the initial charge storage capacity and maintains a high columbic efficiency (e.g., >90%) even at the higher current density of 25 A/g indicating superior rate capacity.

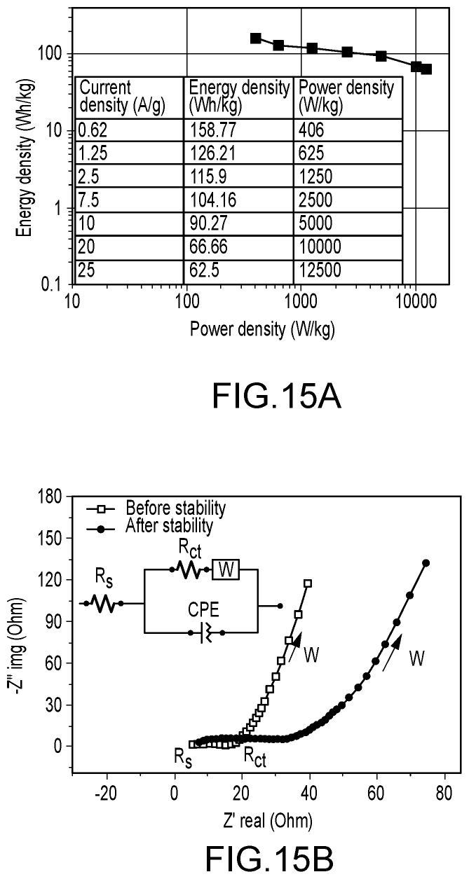

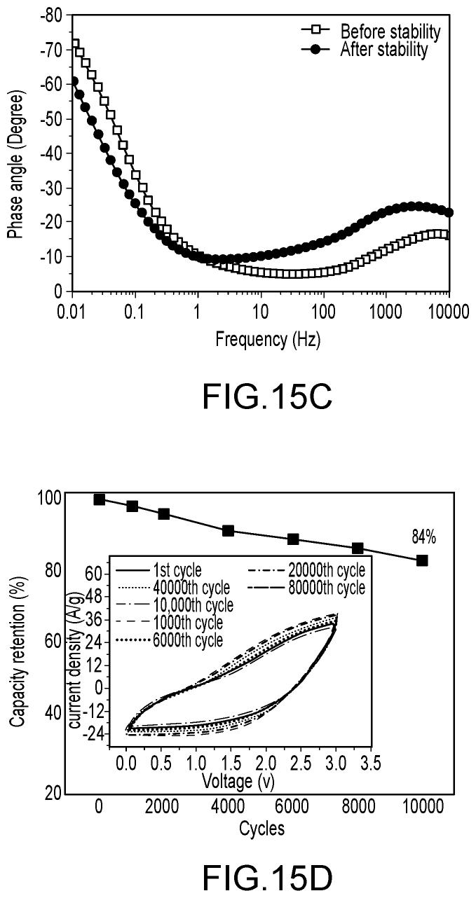

FIG. 15A shows the energy and power density of the fabricated hybrid LIC device. The energy and power density are derived from the Ragone plot also shown in FIG. 15A. The device delivers a maximum energy density of 158.77 Wh/kg and a power density of 406 W/kg at the current density of 0.62 A/g. Even at high current density (e.g., 25 A/g), the device exhibits an ultrahigh power density of 12500 W/kg while retaining a reasonable energy density of 62.5 Wh/kg. The obtained performance is far greater than the conventional EDLCs that may exhibit energy density in the range of 20-30 Wh/kg. The electrochemical kinetics and the charge storage nature of the device is evaluated from the EIS Nyquist plot in FIG. 15B. The plot is composed of three regions, a synchronous region, an asynchronous region, and a no-charge region corresponding to the series resistance (Rₛ), charge transfer resistance (R_{ct}), and Warburg resistance (W), respectively. The lower values of Rₛ (4.68Ω), R_{ct} (16.67Ω), and the parallel nature of the curve to the y-axis in the high frequency ‘no-charge’ region indicate the lower ionic resistance with rapid mass transport. Additionally, the phase angle (−73°) of the device obtained from the Bode plot in FIG. 15C is close to the ideal capacitive component (−90°), indicating excellent charge storage ability. The device stability is an important parameter as it decides its scope for future commercial applications. The stability was evaluated by cycling the device at a 100 mV/s scan rate for continuous 10,000 cycles. As shown in FIG. 15D, the shape of the CV curves is well retained after 10,000 cycles indicating high reversibility for electrochemical reactions. The device exhibits cyclic stability of 84%, highly suitable for commercial applications. Furthermore, the EIS Nyquist and the Bode plot demonstrate high resistance values of the Rₛ (6.60Ω), R_{ct} (35.28Ω) and low phase angle (−61°), indicating slightly reduced diffusion and electrochemical kinetics of the electrodes.

LICs incorporating the metal-sulfide particles in the anode may be applicable to a variety of applications. For example, the LICs incorporating the metal-sul fide particles in the anode may be applicable to consumer electronics, medical devices, defense devices, portable electronics, power tools, electric vehicles, and smart grid systems. However, it is contemplated that the LICs incorporating the metal-sulfide particles in the anode may be applicable to any applications where high power density and high energy density with longer cycle life are desired.

The present technology may provide materials for anodes in lithium-ion applications, such as lithium-ion batteries and LICs. The composite electrodes, including metal-sulfide particles encapsulated by carbon nanoparticles, exhibit electrochemical properties that overcoming shortcomings in conventional electrodes. By preparing metal-sulfide particles and using the metal-sulfide particles in anodes according to embodiments of the present technology, improved energy storage systems may be formed, which may facilitate superior electrochemical performance in terms of higher energy and higher power density.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those skilled in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology. Additionally, methods or processes may be described as sequential or in steps, but it is to be understood that the operations may be performed concurrently, or in different orders than listed.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other state or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a precursor” includes a plurality of such precursors, and reference to “the solution” includes reference to one or more solutions and equivalents thereof known to those skilled in the art.

Also, the words “comprise(s)”, “comprising”, “contain(s)”, “containing”, “include(s)”, and “including”, when used in this speciation and in the following claims, are intended to specify the presence of stated features, integers, components, or operations, but they do not preclude the presence or addition of one or more other features, integers, components, operations, acts, or groups.

What is claimed is:

1. A method of preparing metal-sulfide particles, the method comprising:
preparing a precursor solution, wherein the precursor solution comprises a copper-containing precursor and a metal-containing precursor;
mixing the precursor solution with water to form an aqueous precursor solution;
adding a sulfur-containing precursor to the aqueous precursor solution to form a sulfur-containing aqueous precursor solution;
heating the sulfur-containing aqueous precursor solution; and
recovering a precipitate from the sulfur-containing aqueous precursor solution, wherein the precipitate comprises metal-sulfide particles.

2. The method of claim 1, wherein:
the metal-containing precursor comprises a tin-containing precursor or an iron-containing precursor.

3. The method of claim 1, wherein:
the metal-containing precursor comprises a tin-containing precursor; and
the aqueous precursor solution comprises:
between about 0.05 M and about 0.35 M CuCl₂H₄O₂; and
between about 0.05 M and about 0.20 M SnCl₄.

4. The method of claim 1, further comprising:
adding a carbon-containing material to the aqueous precursor solution.

5. The method of claim 4, wherein:
the carbon-containing material comprise carbon nanotubes or graphene.

6. The method of claim 1, further comprising:
adding a lanthanum-containing precursor, a samarium-containing precursor, or a combination thereof to the precursor solution, the aqueous precursor solution, or the sulfur-containing aqueous precursor solution.

7. A lithium-ion anode, the lithium-ion anode comprising:
metal-sulfide particles, wherein the metal-sulfide particles comprise one or more of copper, tin, or iron; and
a carbon-containing material at least partially encapsulating the metal-sulfide particles.

8. The lithium-ion anode of claim 7, wherein:
the lithium-ion anode comprises a three-dimensional structure having a porous morphology.

9. The lithium-ion anode of claim 7, wherein:
the metal-sulfide particles comprise copper, tin, and sulfur; and
the metal-sulfide particles comprise between about 20 at. % and about 40 at. % copper, between about 5 at. % and about 25 at. % tin, and between about 40 at. % and about 70 at. % sulfur.

10. The lithium-ion anode of claim 7, wherein:
the carbon-containing material comprise carbon nanotubes or graphene.

11. The lithium-ion anode of claim 7, wherein:
the metal-sulfide particles are doped with one or more elements characterized by an atomic number of greater than 50.

12. The lithium-ion anode of claim 7, wherein:
the metal-sulfide particles comprise Cu₂SnS₃.

13. A lithium-ion capacitor, the lithium-ion capacitor comprising:
a cathode;
an anode comprising metal-sulfide particles that are at least partially encapsulated by a carbon-containing material; and
an electrolyte.

14. The lithium-ion capacitor of claim 13, wherein:
the cathode comprises activated carbon.

15. The lithium-ion capacitor of claim 13, wherein:
the electrolyte comprises ethylene carbonate and diethyl carbonate.

16. The lithium-ion capacitor of claim 15, wherein:
the electrolyte further comprises lithium hexafluorophosphate.

17. The lithium-ion capacitor of claim 13, further comprising:
a separator between the cathode and the anode, wherein the separator comprises a polypropylene membrane.

18. The lithium-ion capacitor of claim 13, wherein:
a surface of the anode is characterized by nanospheres ranging in size between about 10 nm and about 75 nm.

19. The lithium-ion capacitor of claim 13, wherein:
the cathode, the anode, or both are formed free of a binder material.

20. The lithium-ion capacitor of claim 13, wherein:
the anode is doped with one or more elements characterized by an atomic number of greater than 50.
